(19) United States
(12) Patent Application Publication
(10) Pub. No.: US 2021/0072403 A1
(43) Pub. Date: Mar. 11, 2021

(54) GNSS RECEIVER

(71) Applicant: DENSO CORPORATION, Kariya-city (JP)

(72) Inventor: Shiro KOIDE, Kariya-city (JP)

(21) Appl. No.: 17/099,406

(22) Filed: Nov. 16, 2020

Related U.S. Application Data
(63) Continuation of application No. PCT/JP2019/019728, filed on May 17, 2019.

(30) Foreign Application Priority Data
May 21, 2018 (JP) 2018-097124

(51) Int. Cl. G01S 19/22; G01S 19/36

(52) U.S. Cl. CPC G01S 19/22; G01S 19/36

(57) ABSTRACT

A GNSS receiver includes an antenna device. Whether an environment around the GNSS receiver is a multipath environment in which an occurrence of multipath is probable. The antenna device is set in a first reception mode with a first directivity in response to not determining that the environment around the GNSS receiver is the multipath environment. In contrast, the antenna device is set in a second reception mode in response to determining that the environment around the GNSS receiver is the multipath environment. The second reception mode is a mode with a second directivity having an elevation angle higher than an elevation angle of the first directivity of the first reception mode.

### CROSS REFERENCE TO RELATED APPLICATIONS

The present application is a continuation application of International Patent Application No. PCT/JP2019/019728 filed on May 17, 2019, which designated the U.S. and claims the benefit of priority from Japanese Patent Application No. 2018-097124 filed on May 21, 2018. The entire disclosures of all of the above applications are incorporated herein by reference.

### TECHNICAL FIELD

The present disclosure relates to a GNSS receiver that receives radio waves transmitted from satellites of Global Navigation Satellite System (hereinafter, GNSS).

### BACKGROUND

The GNSS receiver mounted on a vehicle is required to achieve both high position detection accuracy and downsizing of the entire of the receiver including the antenna. There is a method of removing multipath by signal processing after receiving GNSS signals.

### SUMMARY

According to an example of the present disclosure, a GNSS receiver includes an antenna device. Whether an environment around the GNSS receiver is a multipath environment in which an occurrence of multipath is probable. The antenna device is set in a first reception mode with a first directivity in response to not determining that the environment around the GNSS receiver is the multipath environment. In contrast, the antenna device is set in a second reception mode in response to determining that the environment around the GNSS receiver is the multipath environment. The second reception mode is a mode with a second directivity having an elevation angle higher than an elevation angle of the first directivity of the first reception mode.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram explaining a configuration of a GNSS receiver according to a first embodiment;

FIG. 2 is a block diagram illustrating a configuration of an antenna device;

FIG. 3 is a block diagram illustrating a configuration of a controller;

FIG. 4A is a diagram illustrating a method of correcting a phase shift of an elevation angle and an azimuth of an antenna;

FIG. 4B is a diagram illustrating a method of correcting a phase shift of an elevation angle and an azimuth of an antenna;

FIG. 4C is a diagram illustrating a method of correcting a phase shift of an elevation angle and an azimuth of an antenna;

FIG. 5 is an example of a diagram of correction parameters;

FIG. 6 is a flowchart of a mode setting process according to the first embodiment;

FIG. 7 is a diagram illustrating a modified example of an antenna device;

FIG. 8 is a diagram illustrating a modified example of an antenna device;

FIG. 9 is a block diagram illustrating a configuration of a GNSS receiver according to a second embodiment;

FIG. 10 is a flowchart of a mode setting process according to the second embodiment.

### DETAILED DESCRIPTION

Embodiments of the present disclosure will be described below with reference to the drawings.

### 1. First Embodiment

### 1-1. Overall Configuration

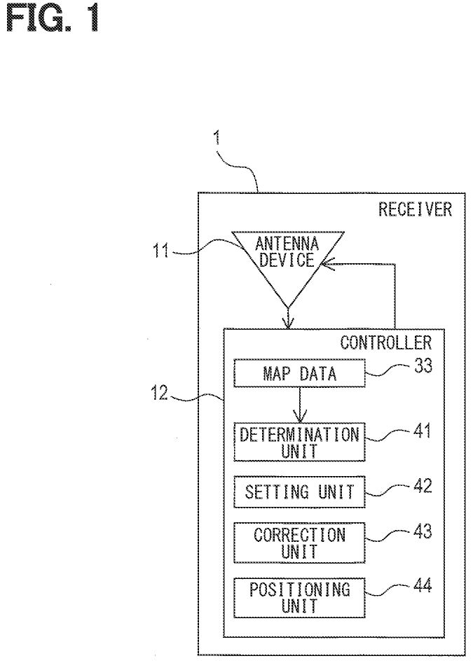

A GNSS receiver 1 shown in FIG. 1 is mounted on a vehicle for use. The GNSS receiver 1 includes an antenna device 11 and a controller 12, which are communicably connected with each other via a communication link.

### 1-2. Antenna Device

The antenna device 11, which includes at least one antenna, has two reception modes of a first reception mode and a second reception mode. The first reception mode is a mode in which reception is performed with a first directivity having a first elevation angle. The second reception mode is a mode in which reception is performed with a second directivity having a second elevation angle that is higher than the first elevation angle of the first directivity in the first reception mode. If the directivity of the antenna has a high elevation angle, it is possible to improve the reception sensitivity of a signal reaching the antenna from an upper.

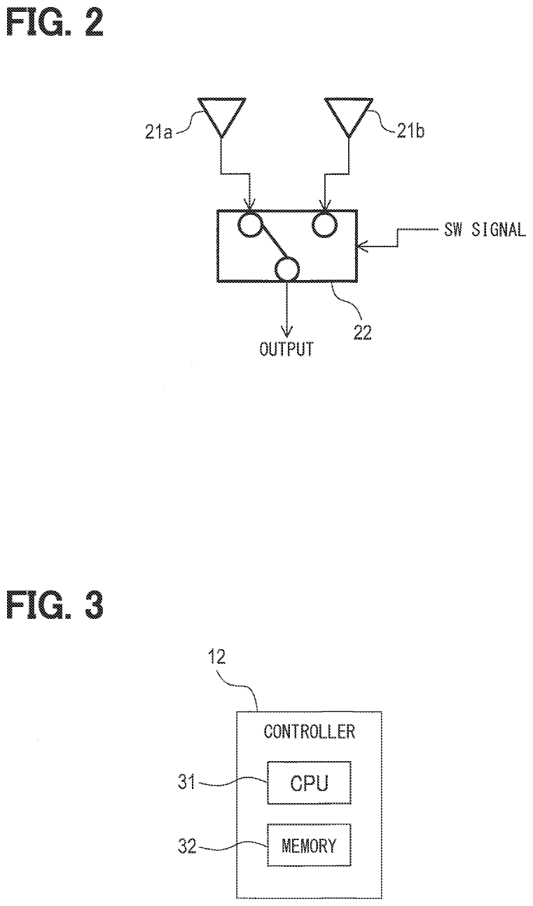

As shown in FIG. 2, the antenna device 11 may include two patch antennas 21a and 21b and an RF switch 22. The patch antenna 21a is an antenna having a directivity with a relatively low elevation angle (i.e., a lower elevation angle). The patch antenna 21b is an antenna having a directivity with a relatively high elevation angle (i.e., a higher elevation angle). The RF switch 22 receives a switching signal output from the controller 12, and switches the antenna, which outputs a signal to the controller 12, to either the patch antenna 21a or the patch antenna 21b. Such switching by the RF switch 22 sets an operation mode of the antenna device 11. The operation mode in which the patch antenna 21a outputs a reception signal is the above-mentioned first reception mode; the operation mode in which the patch antenna 21b outputs a reception signal is the above-mentioned second reception mode.

### 1-3. Controller

As shown in FIG. 3, the controller 12 includes a microcomputer including a CPU 31 and a semiconductor memory (hereinafter, memory 32) such as RAM or ROM. Functions provided by the controller 12 are implemented by the CPU 31 executing a program stored in the non-transitory tangible storage medium. In this example, the memory 32 corresponds to a non-transitory tangible storage medium for storing a program. With the execution of the program, a method corresponding to the program is executed. The controller 12 may include one or more microcomputers.

As shown in FIG. 1, the controller 12 includes a determination unit 41 and a setting unit 42. Further, the controller 12 may include a correction unit 43 and a positioning unit 44. The method of implementing the functions of the respective units included in the controller 12 is not limited to software, and a part or all of the functions thereof may be implemented by using one or a plurality of hardware circuits. For example, when the above-described functions may be implemented by an electronic circuit which is hardware, the electronic circuit may be implemented by a digital circuit, an analog circuit, or a combination thereof.

In other words, the controller 12 and the techniques thereof according to the present disclosure may be implemented as one or more special-purposed computers. Such a special-purposed computer or the controller 12 may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits.

The determination unit 41 is configured to determine whether the environment around the GNSS receiver 1 is a multipath environment, which is an environment in which an occurrence of multipath is probable. The determination unit 41 is configured to be able to refer to map data 33. The map data 33 stores a range on map (i.e., an on-map range) that is predetermined as a multipath environment on map. In the following description, this range is referred to as a multipath area. Examples of the multipath area include, but are not limited to, an area with many high-rise buildings that may cause the multipath.

The determination unit 41 compares the current position, which is specified based on the received GNSS signals, with the multipath area stored in the map data 33. The determination unit 41 determines that the GNSS receiver 1 is in a multipath environment when the current position is in the multipath area. When the GNSS receiver 1 is not located in the multipath area, the determination unit 41 determines that the GNSS receiver 1 is not in the multipath environment.

The setting unit 42 is configured to set the antenna device 11 in the first reception mode when the determination unit 41 has not determined that the surrounding environment is the multipath environment. The setting unit 42 is configured to set the antenna device 11 in the second reception mode when the determination unit 41 has determined that the surrounding environment is the multipath environment.

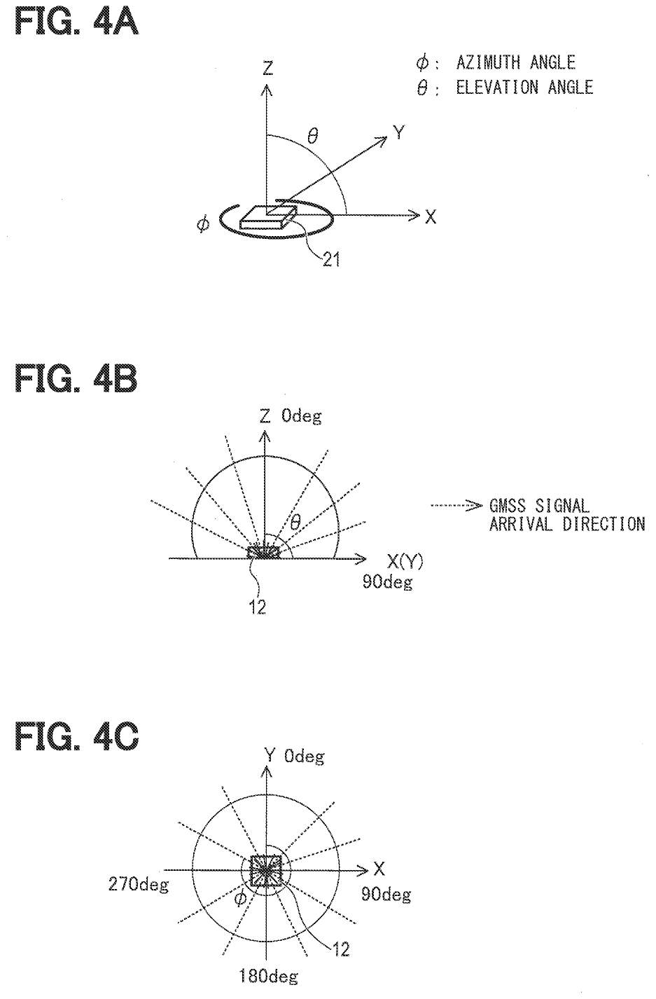

The correction unit 43 is configured to correct the phase shift of (i) the elevation angle and (ii) the azimuth of at least one antenna using a correction parameter specific to the antenna. A method of correcting the phase shift of the elevation angle and the azimuth of the antenna by the correction unit 43 will be described with reference to FIGS. 4A, 4B, and 4C.

As shown in FIG. 4A, assume a patch antenna 21 arranged in the XY plane. The deviation of the antenna phase center is calculated by changing the elevation angle ⊖ and the azimuth angle Φ in the direction in which the GNSS signal arrives at the patch antenna 21. Then, the correction parameter is set so as to reduce the deviation. The elevation angle ⊖ is an angle indicating a tilt with respect to the Z axis as shown in FIG. 4B. The azimuth angle Φ is an angle indicating a horizontal direction about the Z axis as shown in FIG. 4C.

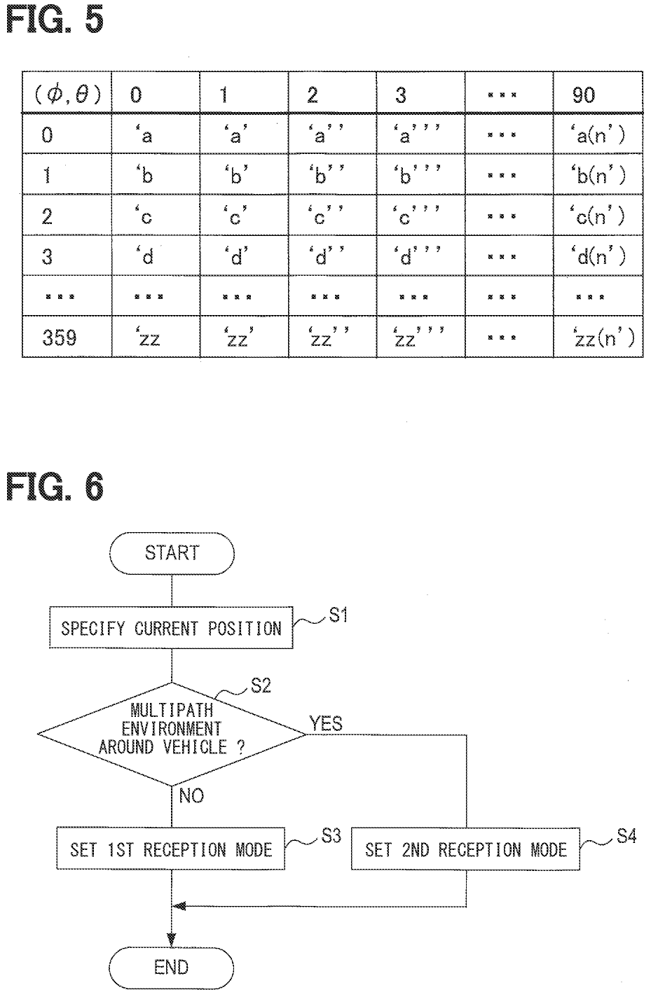

FIG. 5 is an example of a diagram of a table showing correction parameters. This table is stored in the memory 32. This table shows the correction parameters for the elevation angle ⊖ in the range of 0 to 90 degrees for each one (1) degree and for the azimuth angle Φ in the range of 0 to 359 degrees for each one (1) degree. This correction parameter is a unique value for each antenna, and individual differences easily occur. Therefore, it is desirable to actually measure and determine the correction parameter for each antenna or for each group such as a manufacturing lot that has a small change. By correcting the antenna output value using this correction parameter, the phase shift of the elevation angle and azimuth of the antenna is suppressed; thereby, the antenna phase center is suppressed from being shifted depending on the direction of the GNSS satellite with reference to the patch antenna 21. Since the GNSS receiver 1 includes the correction unit 43, the antenna accuracy can be improved by an approach other than the suppression of the influence of multipath.

The positioning unit 44 is configured to specify the current position of the GNSS receiver 1, that is, the current position of the vehicle, based on the received GNSS signals. The function of the positioning unit 44 is a known function.

### 1-3. Process

Next, a mode setting process executed by the CPU 31 of the controller 12 will be described with reference to the flowchart of FIG. 6. This process is executed at a predetermined cycle.

First, in S1, the CPU 31 specifies the current position of the GNSS receiver 1 based on the signals from the GNSS satellites.

In S2, the CPU 31 determines whether the environment around the GNSS receiver 1 is a multipath environment. That is, it is determined whether the current position obtained in S1 is located in the multipath area. When the CPU 31 determines in S2 that the environment is not the multipath environment, the CPU 31 proceeds to S3. On the other hand, when the CPU 31 determines in S2 that the environment is the multipath environment, the CPU 31 proceeds to S4.

In S3, the CPU 31 sets the reception mode to the first reception mode. Then, this process ends.

In S4, the CPU 31 sets the reception mode to the second reception mode. Then, this process ends.

### 1-5. Effects

According to the first embodiment described in detail above, the following effects are obtained.

(1a) The GNSS receiver 1 receives the radio waves output from the GNSS satellites in the second reception mode when the surrounding environment is a multipath environment. Since the directivity in the second reception mode has a relatively high elevation angle, the influence of the reflected waves having a low elevation angle can be suppressed as compared with the first reception mode. As a result, the deterioration of the positioning accuracy due to multipath is suppressed; thereby the accuracy of the detected position can be improved. Further, when the GNSS receiver 1 is not in the multipath environment, the GNSS receiver 1 is set to the first reception mode, where the GNSS signals can be received in a range of a wide elevation angle.

(1b) In the GNSS receiver 1, the correction unit 43 corrects the phase shift of the elevation angle and the azimuth of the patch antenna 21, and suppresses the error due to the incident angle of the GNSS signals at the antenna phase center. Thereby, the receiving accuracy of the antenna can be improved.

(1c) In the GNSS receiver 1, the determination unit 41 determines whether the environment is the multipath environment based on the position of the GNSS receiver 1 on the map. Therefore, it is possible to accurately switch the reception mode.

### 1-6. Modified Example of Antenna Device

If the antenna device 11 includes at least one antenna and is configured to implement two reception modes of a first reception mode and a second reception mode, various configurations different from the configuration of the first embodiment can be adopted.

For example, the antenna device 11 may use an array antenna including a plurality of antenna elements as the at least one antenna. Since an array antenna can electronically control directivity, it can be used as an antenna included in the antenna device 11 of the present disclosure.

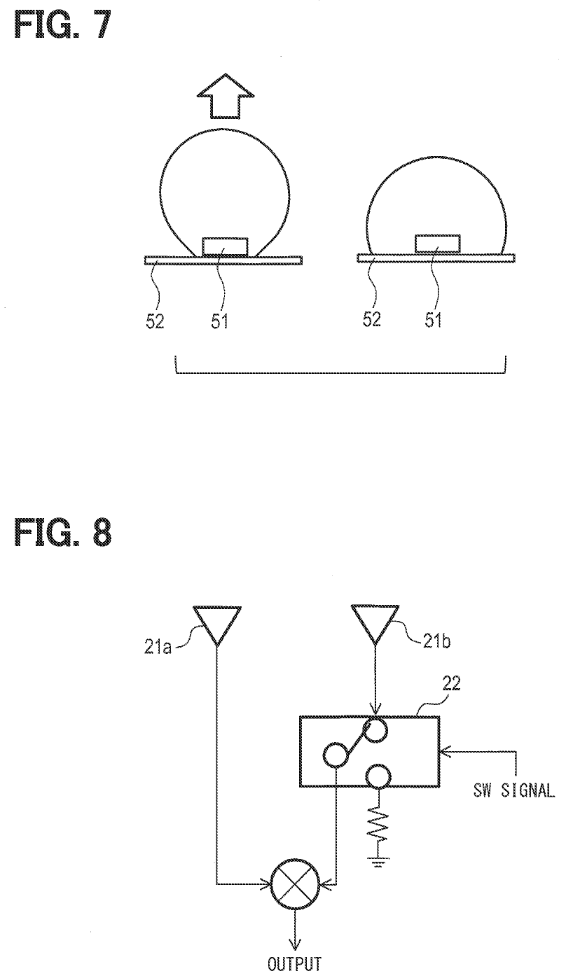

Further, as shown in FIG. 7, the shape of the base plate 52 of the antenna 51 may be controllable. The directivity of the antenna 51 can be controlled by changing the size and shape of the base plate 52.

Further, the specific configuration of the directivity control by switching the antenna using the RF switch is not limited to the configuration of FIG. 2. For example, as shown in FIG. 8, the RF switch 22 may be configured to switch to either (i) a reception mode which outputs a signal of the patch antenna 21a itself or (ii) a reception mode which outputs a combined signal of the patch antenna 21a and the patch antenna 21b, based on a switching signal from the controller 12. In this case, the directivities of the patch antenna 21a and the patch antenna 21b are made different, so that the directivity can be made different depending on the reception mode.

Further, the number of antennas included in the antenna device 11 is not particularly limited, and may include three or more antennas. Further, the number of reception modes may be three or more. That is, the types of directivity that can be implemented by the entire antenna device are not limited to two types, and may be three or more types.

### 2. Second Embodiment

### 2-1. Differences from First Embodiment

The fundamental configuration of a second embodiment is similar to that of the first embodiment. Therefore, the difference therebetween will be described below. The same reference numerals as in the first embodiment denote the same components, and reference is made to the preceding description.

The above-described first embodiment illustrates the configuration which determines whether the environment around the GNSS receive 1 is a multipath environment by referring to the map data 33. On the other hand, the second embodiment is different from the first embodiment in that it determines whether the environment is a multipath environment based on a captured image of a camera that captures an area external to the vehicle.

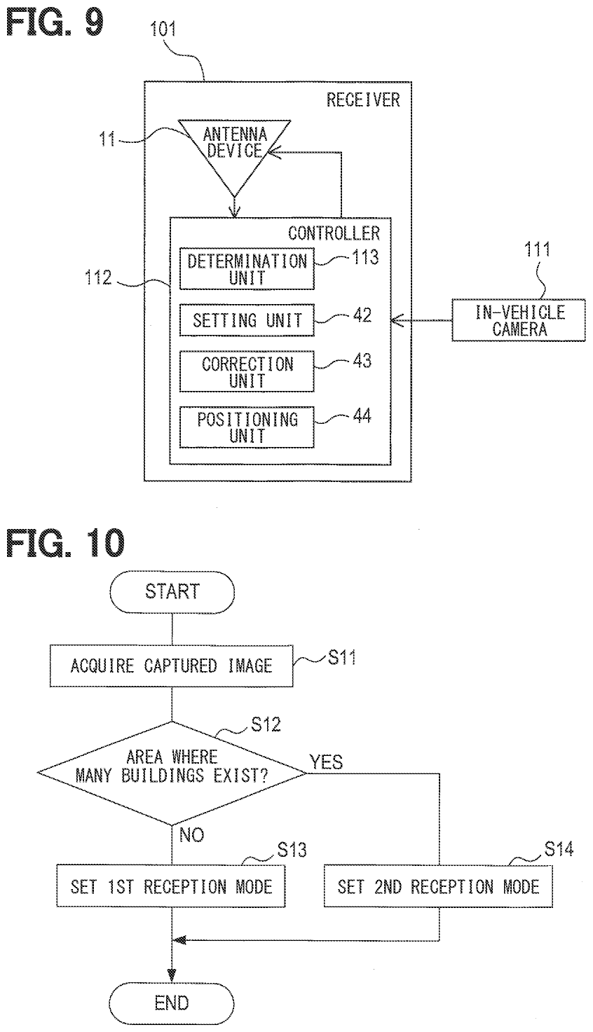

As shown in FIG. 9, a GNSS receiver 101 is configured to be able to communicate with an in-vehicle camera 111 configured to be able to capture an image of an area outside of the vehicle. A determination unit 113 of a controller 112 is configured to acquire a captured image by the in-vehicle camera 111 and identify whether the environment around the vehicle is a multipath environment based on the captured image by the in-vehicle camera 111. The in-vehicle camera 111 corresponds to an imager.

### 2-2. Process

Next, a mode setting process executed by the CPU 31 of the controller 112 according to the second embodiment in place of the mode setting process (FIG. 6) of the first embodiment will be described with reference to the flowchart of FIG. 10.

First, in S11, the CPU 31 acquires a captured image of the in-vehicle camera 111.

In S12, the CPU 31 analyzes the captured image acquired in S11, and determines whether the area is where many buildings exist. The specific image analysis and determination method is not particularly limited. Suppose a case where the ratio of the captured images of the buildings to the captured images captured within a certain period of time is equal to or greater than a predetermined threshold value. In such a case, the determination unit 113 determines that the GNSS receiver 101 is located in an area where many buildings exist. The method of determining whether the captured image is capturing a building is not particularly limited. Suppose, in a captured image, (i) pixels are in a previously learning range with respect to any one or more of lightness, saturation, and hue, and (ii) the ratio of the pixels among all the pixels of the captured image is in a reference ratio. Such a captured image may be determined to be an image capturing a building. Of course, whether a captured image is an image capturing a building may be determined by another method.

When the CPU 31 determines in S12 that the area is not an area where many buildings exist, the CPU 31 proceeds to S13. On the other hand, when the CPU 31 determines in S12 that the area is an area where many buildings exist, the CPU 31 proceeds to S14.

Note that the processing of S13 and S14 in FIG. 10 is the same as the processing of S3 and S4 in FIG. 6.

### 2-3. Effects

According to the second embodiment described in detail above, the effects (1a) and (1b) of the first embodiment described above are exhibited, and further the following effects are exhibited.

(2a) In the GNSS receiver 101, the determination unit 41 determines whether the multipath environment is set based on the image captured by the in-vehicle camera 111. Therefore, it is possible to accurately switch the reception mode.

### 2-4. Modified Example of Multipath Environment Determination Method

The specific method for determining whether the environment is a multipath environment based on the captured image around the vehicle is not limited to the method of the above embodiment. For example, the determination unit 113 may determine a size of the visible range of the sky from the captured image and determine whether the environment is a multipath environment based on the size. Further, the determination unit 113 may acquire a predetermined installation object other than buildings, for example, a sign from the captured image, and determine whether the environment is a multipath environment based on, of the sign, the type, the number, the installation frequency, and the like.

### 3. Other Embodiments

Although the embodiments of the present disclosure have been described above, the present disclosure is not limited to the embodiments described above, and various modifications can be made to implement the present disclosure.

(3a) The above embodiments exemplify a configuration for determining whether the environment around the GNSS receiver is a multipath environment based on map data or a captured image around the vehicle. However, it is not limited thereto. For example, the determination may be made based on (i) the ratio of the GNSS signal having a lower elevation angle among all the GNSS signals having respective elevation angles or (ii) a change in the ratio. Further, the determination may be made based on the traveling speed of the vehicle, the stop frequency, or the like.

(3b) The above embodiments exemplify a configuration in which the correction unit 43 corrects the phase shift of the elevation angle and the azimuth with reference to the table shown in FIG. 5. However, it is not limited thereto. For example, the correction data may be received by a device provided outside the vehicle such as an external server by a cellular communication or the like without storing the correction data by itself.

(3c) Multiple functions of one element in the above embodiments may be implemented by multiple elements, or one function of one element may be implemented by multiple elements. Further, multiple functions of multiple elements may be implemented by one element, or one function implemented by multiple elements may be implemented by one element. In addition, a part of the configuration of the above embodiments may be omitted. At least a part of the configuration of the above embodiments may be added to or replaced with another configuration of the above embodiments. All features included in the technical idea identified by the wording described in claims correspond to embodiments of the present disclosure.

(3d) The present disclosure may be implemented in the various forms in addition to the GNSS receiver described above, such as a system having the GNSS receiver as a constituent element, a program for causing a computer to function as a controller of the GNSS receiver, a non-transitory tangible storage medium like a semiconductor memory storing the program, a signal receiving method.

For reference to further explain features of the present disclosure, the description is added as follows.

The GNSS receiver mounted on a vehicle is required to achieve both high position detection accuracy and downsizing of the entire of the receiver including the antenna. There may be a method of removing multipath by signal processing after receiving GNSS signals.

Detailed study by the inventor has found the following issues in the above method. That is, the data before multipath reception is used to remove the multipath data by the processing after the multipath reception, so the processing load tends to increase. The output of the calculation result is thus delayed, which may make it difficult to provide position data in real time. Further, if the multipath itself interferes with the originally desired direct wave, the influence due to the multipath cannot be removed.

It is thus desired to improve the accuracy of the position detected by a GNSS receiver.

An aspect of the present disclosure described herein is set forth in the following clauses.

According to an aspect of the present disclosure, a GNSS receiver, which is used to be mounted on a vehicle, includes an antenna device, a determination unit, and a setting unit. The antenna device includes at least one antenna. The antenna device is configured to implement two reception modes of a first reception mode and a second reception mode. The first reception mode is a mode in which reception is performed with a first directivity having a first elevation angle. The second reception mode is a mode in which reception is performed with a second directivity, the second directivity having a second elevation angle that is higher than the first elevation angle of the first directivity. The determination unit is configured to determine whether an environment around the GNSS receiver is a multipath environment in which an occurrence of multipath is probable. The setting unit is configured to set the antenna device in the first reception mode. In contrast, the setting unit is configured to set the antenna device in the second reception mode.

According to such a configuration, when the environment around the GNSS receiver is a multipath environment, the radio waves output from the GNSS satellites are received in the second reception mode. Since the second reception mode has the second directivity with a relatively high elevation angle, the influence of the reflected wave having a low elevation angle can be suppressed as compared with the first reception mode. As a result, the deterioration of the positioning accuracy due to multipath is suppressed, and the accuracy of the detected position can be improved.

What is claimed is:

1. A GNSS receiver mounted on a vehicle, comprising:
an antenna device including at least one antenna, the antenna device being configured to implement two reception modes of a first reception mode and a second reception mode,
the first reception mode in which reception is performed with a first directivity having a first elevation angle,
the second reception mode in which reception is performed with a second directivity having a second elevation angle that is higher than the first elevation angle of the first directivity;
a determination unit configured to determine whether an environment around the GNSS receiver is a multipath environment in which an occurrence of multipath is probable; and
a setting unit configured to
set the antenna device to the first reception mode in response to the determination unit not determining that the environment around the GNSS receiver is the multipath environment, and
set the antenna device to the second reception mode in response to the determination unit determining that the environment around the GNSS receiver is the multipath environment,
wherein:
the determination unit is further configured to determine whether an environment around the vehicle is the multipath environment based on (i) a ratio of a GNSS signal having a lower elevation angle or (ii) a change in the ratio.

2. The GNSS receiver according to claim 1, further comprising:
a correction unit configured to correct a phase shift of (i) an elevation angle and (ii) an azimuth of the at least one antenna, using a correction parameter specific to the antenna.

3. The GNSS receiver according to claim 1, wherein:
the determination unit is configured to determine that the environment around the GNSS receiver is the multipath environment in response to the GNSS receiver being located in a range designated as a range on map of the multipath environment.

4. The GNSS receiver according to claim 1, wherein:
the determination unit is configured to
acquire a captured image captured by an imager configured to capture an image of an area outside of the vehicle, and
determine whether the environment around the vehicle is the multipath environment based on the captured image by the imager.

5. The GNSS receiver according to claim 1, wherein:
the at least one antenna in the antenna device includes a patch antenna.

6. A GNSS receiver mounted on a vehicle, comprising:
an antenna device including at least one antenna, the antenna device being configured to implement two reception modes of a first reception mode and a second reception mode,
the first reception mode in which reception is performed with a first directivity having a first elevation angle,
the second reception mode in which reception is performed with a second directivity having a second elevation angle that is higher than the first elevation angle of the first directivity; and
a controller connected with the at least one antenna, the controller being configured to
determine whether an environment around the GNSS receiver is a multipath environment in which an occurrence of multipath is probable,
set the antenna device to the first reception mode in response to not determining that the environment around the GNSS receiver is the multipath environment, and
set the antenna device to the second reception mode in response to determining that the environment around the GNSS receiver is the multipath environment,
wherein:
the controller is further configured to determine whether the environment around the GNSS receiver is the multipath environment by determining whether an environment around the vehicle is the multipath environment based on (i) a ratio of a GNSS signal having a lower elevation angle or (ii) a change in the ratio.
